(19) United States
(12) Patent Application Publication
(10) Pub. No.: US 2009/0071845 A1
(43) Pub. Date: Mar. 19, 2009

(54) COATING PLANT COMPRISING AT LEAST ONE PRE-TREATMENT UNIT

(76) Inventor: Boris Muller, Helmstedt (DE)

Correspondence Address: BASF CORPORATION;Patent Department, 1609 BIDDLE AVENUE, MAIN BUILDING, WYANDOTTE, MI, 48192, US

(21) Appl. No.: 11/574,412

(22) PCT Filed: Sep. 6, 2005
(86) PCT No.: PCT/EP2005/054512

§ 371 Date: Nov. 14, 2008

(30) Foreign Application Priority Data
Sep. 30, 2004 (DE) 10 2004 047 532.6

(51) Int. Cl. B01J 19/08

(52) U.S. Cl. 205/759; 204/242; 204/275.1

(57) ABSTRACT

A coating installation, comprising at least one apparatus for pretreating the substrates to be coated (pretreatment installation), at least one apparatus for coating the substrate with coating substances (coating apparatus), and at least one apparatus for drying and hardening the applied coating substances (hardening apparatus), wherein at least one of the pretreatment installations comprises at least one arrangement for the anodic oxidation of the deionized, i.e. fully de-mineralized, water used in the pretreatment installation with at least one electrode, the electrode having a layer (3) of diamond, on a base body (1, 2) as shown in FIG. 1, and a method for sterilizing a pretreatment installation for a coating installation, in which deionized water used in the pretreatment installation is anodically oxidized with the aid of at least one electrode, which has a layer (3) of diamond on a base body (1, 2), the voltage at the electrode during operation always being below the potential range at which relatively large amounts of oxygen are evolved at the electrode.

The present application claims the priority of DE 10 2004 047 532.6-26.

The present invention relates to a coating installation, comprising at least one apparatus for pretreating the substrates to be coated (pretreatment installation), at least one apparatus for coating the substrate with coating substances (coating apparatus), and at least one apparatus for drying and hardening the applied coating substances (hardening apparatus). It also relates to a novel coating installation, in particular a painting installation, comprising at least one pretreatment installation. Furthermore, the present invention relates to novel method for sterilizing pretreatment installations in coating installations, in particular painting installations.

A coating installation, in particular a painting installation, usually comprises at least three apparatuses which are used to carry out the three basic process steps of coating technology

### 1. Pretreatment,

### 2. Painting,

3. Drying and hardening
(cf. in this respect, by way of example, A. Goldschmidt and H.-J Steitberger, BASF Handbuch Lackiertechnik, [Painting Technology Handbook], BASF Coatings AG, Vincentz Verlag, Hanover, 2002“4.1.2.3 Pretreatment”, pages 470 to 481, together with “4. Painting Technology”, page 453, FIG. 4.1 “Process steps used in a painting installation”).

In this context, the success of the painting is highly dependent on the quality of pretreatment of the substrates to be painted. This applies in particular to the painting of high-quality goods, such as automobiles, in particular luxury passenger automobiles, with particular high-quality coatings. For example, damage which occurs during the pretreatment in practice can no longer be eliminated by the subsequent painting, even if the painting is completely free of any defects, since, for example, particles which are deposited on the substrate during the pretreatment remain clearly visible in the final coatings, which is unacceptable to the customer. The coatings in question then have to undergo complex further treatment or repair painting, in the most serious of cases even over their entire surface.

It is known that the pretreatment installations of painting installations used for automotive OEM Finishing are operated with deionized, i.e. fully demineralized, water in the activation zones and the rinsing zones. On account of water temperatures around 30 to 45° C., long tank lifespans and/or contamination by phosphates, the associated work-up installations, storage tanks and pipes for the deionized water offer an ideal environment for microorganisms, which under certain circumstances may multiply suddenly and hugely, forming extensive biofilms which grow on the inner walls of the pretreatment installations. These biofilms can then unpredictably become detached from the walls, deposited on the substrates and thereby cause coating defects.

Biofilms often prove highly resistant to chemical disinfection, which has only a temporary action and involves high costs, since the use of disinfectants is generally restricted to the times when the installations are not operating, in order to avoid undesirable interactions with pretreatment chemicals. Moreover, it is necessary to prevent the disinfecting chemicals used from being entrained into other parts of the installation, for example electrophoretic enameling baths, where they can undesirably change the coating substances. An additional difficulty is that impact disinfection can intensify the detachment of biofilms. Even completely or virtually completely preventing the growth of biofilms in the pretreatment installations by sterilizing the deionized water with the aid of short-wave, germicidal UV radiation does not produce the desired success, since the UV radiation only reaches the regions which are exposed to the direct beam path. Shadow zones, pipelines or bends cannot be reached. Moreover, the UV radiation is only in position to deactivate the microorganisms, but cannot eliminate the organic residues, such as the biofilms, which remain in the deionized water and serve as additional nutrient sources or growth points.

European patent application EP 0 994 074 A2 has disclosed an arrangement and a method for the anodic oxidation of aqueous solutions, which uses electrodes which have a conductive layer of doped diamond on their surface and are operated in a potential range in which oxygen is not evolved at the electrodes, but, highly reactive hydroxide radicals are formed as oxidizing agents.

The arrangement and method are supposed to be used to disinfect drinking water or to maintain sterile conditions in pipe systems used in relatively large complexes, such as hospitals, hotels, care homes and swimming baths, to treat waste waters in industrial installations and/or to treat waste waters which are particularly highly polluted or are polluted with organic compounds that are difficult to destroy, to reliably sterilize air-conditioning systems, to remove organic components from waste waters, for example to remove lubricants from machining plants, or in general terms to remove organic residues from the chemical, pharmaceutical and cosmetic industries and organic additives from electroplating wastes or to destroy inorganic compounds, such as cyanide, in waste waters. The intention is also to allow treatment of baths which are operated with organic additives, for example for cleaning purposes in the manufacturing industry. Once the additives in question have been consumed, it is no longer necessary to replace the entire bath, but rather the additives or their residues can be deliberately destroyed, after which it is simply necessary to add fresh additives in the desired amount.

The abovementioned European patent application does not give any suggestion that the associated apparatus and method could be used in a coating installation, in particular a painting installation, to solve the complex problems described above.

It is an object of the present invention to provide a novel coating installation, in particular a painting installation, which comprises at least one pretreatment installation and no longer has the drawbacks of the prior art, but rather provides coatings, in particular especially high-quality coatings, and especially automotive OEM finishes, which are completely or virtually completely free of coating defects.

A further object of the present invention is to provide a novel method for sterilizing a pretreatment installation for a coating installation, in particular a painting installation, which no longer has the drawbacks of the prior art, but rather effectively prevents in particular the formation of biofilms in the deionized water which is used in the pretreatment installation, in particular in the activation zone and the rinsing zone. However, the novel method is not only supposed to prevent the formation of biofilms, but, also to effectively eliminate biofilms which have already been formed and/or have become detached again from the walls, so that there can no longer be any undesirable deposits on the substrates. This is to be ensured even at deionized water temperatures of 30 to 45° C., with long tank lives and/or in the event of phosphate contamination. Furthermore, the intention is not that the novel method should be active for a short time, but rather that is should have a long-term effect. Not least, the novel method is also intended to prevent disinfectants from being entrained into other parts of the coating installation, in particular painting installation, where they could damage coating substances.

Accordingly, the novel coating installation, comprising at least one apparatus for the pretreatment, of the substrates to be coated (pretreatment installation, at, least one apparatus for coating the substrates with coating substances (coating apparatus), and at least one apparatus for drying and hardening the applied coating substances (hardening apparatus), was discovered, wherein at least one of the pretreatment installations comprises at least one arrangement for the anodic oxidation of the deionized, i.e. fully demineralized, water used in the pretreatment, installation with at least one electrode, the electrode having a layer of diamond, on a base body.

In the text which follows, the novel coating installation is referred to as the “installation according to the invention”.

Moreover, the invention has also discovered the novel method for sterilizing a pretreatment installation in a coating installation as above, in which the deionized water used in the pretreatment installation is anodically oxidized with the aid of at least one electrode, which has a layer of diamond on a base body, the voltage at the electrode during operation always being below the potential range at which oxygen is evolved at the electrode.

The novel method is used to sterilize a pretreatment installation for a coating installation and is referred to below as the “method according to the invention”.

In view of the prior art, it was surprising and not obvious to a person skilled in the art that the object on which the present invention was based could be achieved with the aid of the installation according to the invention and the method according to the invention.

In particular, it was surprising that the installation according to the invention no longer had the drawbacks of the prior art, but rather allowed the production of coatings, in particular particularly high-quality coatings, especially automotive OEM finishes, which were completely or virtually completely free of coating defects.

In this context, the term “virtually completely free of coating defects” is to be understood as meaning that the automotive OEM finishes in question had only a very small number of coating defects, which have no adverse effect on the technological properties and overall visual appearance of the automotive OEM finishes.

It was especially surprising, however, that the method according to the invention likewise no longer had the drawbacks of the prior art, but rather effectively prevented in particular the formation of biofilms in the deionized water which was used in the pretreatment installation according to the invention, in particular in the activation zone and the rinsing zone. However, the method according to the invention not only performed this function but also effectively eliminated biofilms which had already been formed and/or had become detached again from the walls, so that it was no longer possible for there to be any undesirable deposits on the pretreated substrates. This was ensured even at deionized water temperatures of from 35 to 45° C., with long tank lives and/or in the event of phosphate contamination. Furthermore, the method according to the invention was not active for just a short time, but, rather had a long-term effect. Not least, the method according to the invention was able from the outset to prevent disinfectants from being entrained into other parts of the coating installation, in particular painting installation, where they would damage the coating substances.

The apparatus according to the invention comprises at least three apparatuses which are used to carry out the three basic process steps of coating technology

### 1. Pretreatment,

### 2. Painting,

3. Drying and hardening
(cf. in this respect, by way of example, A. Goldschmidt and H.-J Steitberger, BASF Handbuch Lackiertechnik, [Painting Technology Handbook], BASF Coatings AG, Vincentz Verlag, Hanover, 2002 “4. Painting Technology”, page 453, FIG. 4.1 “Process steps used in a painting installation”). The installation according to the invention is in particular a painting installation for automotive OEM finishing.

Painting installations of this type comprise pretreatment installations, which are used in particular to preclean, rinse, phosphate, passivate and re-rinse the coated substrates, in particular the automobile bodies. The pretreatment installation is generally followed by apparatuses for electrophoretic dip coating, apparatuses for applying seam seals and underbody protective coatings, fillers and topcoats, in particular basecoats and clearcoats, as well as apparatuses for drying and hardening the corresponding layers which have been applied, and in the context of the invention these apparatuses are referred to in combination as the coating apparatus (cf. in this respect, by way of example, A. Goldschmidt and H.-J Streitberger, BASF Handbuch Lackiertechnik [Painting Technology Handbook], BASF Coatings AG, Vincentz Verlag, Hanover, 2002 “7.1 Automotive OEM finishing”, pages 714 to 737, in particular page 717, FIG. 7.1.5 “Typical, process steps used in a painting installation in the automotive industry” and “7.1.1 Pretreatment” pages 718 to 721, together with “4.1.2.3 Pretreatments”, pages 470 to 481).

According to the invention, at least one of the pretreatment, installations, in particular all the pretreatment installations, of the installation according to the invention comprises at least one arrangement, preferably at least two arrangements, for the anodic oxidation of the deionized, i.e. fully demineralized, water used in the pretreatment installation.

The arrangement which is to be used according to the invention for the anodic oxidation of the deionized water used in the pretreatment installation (this arrangement being referred to below simply as the “arrangement” for short) comprises at least one electrode which comprises a layer (3) in particular a large-area layer (3), of diamond on a base body (1, 2).

The layer (3) of diamond is preferably from 2 to 50 micrometers thick.

The layer (3) is preferably doped. It is particularly preferable for the dopant used to be boron. It is very particularly preferable for the boron doping to amount to between 10 ppm and 10000 ppm.

Preferably, the base body (1, 2), beneath the layer (3) of diamond, comprises a self-passivating metal, in particular titanium, niobium, tantalum, zirconium, tungsten or an alloy comprising at least one of the metals, silicon, silicon carbide, silicon-infiltrated silicon carbide, or silicon-based ceramics.

It is preferable for a bonding intermediate layer which is oxidation-stable during the electrolysis, in particular a metal carbide layer, to be arranged between the base body (1, 2) and the layer (3) of diamond.

It is particularly preferable for the base body (1, 2) to have a core (1) of a conductive material, which is surrounded by a sheath (2) of the self-passivating metal.

It is very particularly preferable for the base body (1, 2) to be formed from expanded metal.

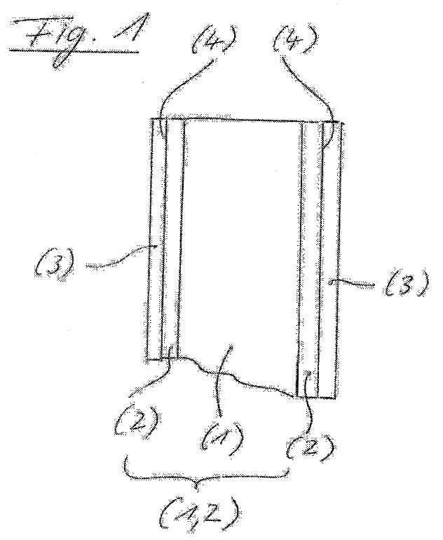

The electrode that is to be used according to the invention is diagrammatically depicted by FIG. 1, i.e. the sizes are not to scale. In FIG. 1, the reference designations have the following meaning:
(1, 2) base body,
(1) core,
(2) sheath,
(3) layer of diamond, and
(4) intermediate layer.

It is preferable for the arrangement to be connected to the activation zone or the rinsing zone, particularly the activation zone and the rinsing zone, of the pretreatment installation. It is very particularly preferable for the connection or connections to be configured in such a manner that the deionized water can be circulated through the arrangement.

Furthermore, the arrangement may comprise conventional and known, electronic, mechanical and pneumatic apparatuses, such as pumps for passing the deionized water through the arrangement and the pipes, electronic, mechanical and pneumatic measurement and control apparatuses, in particular for measuring the concentration of the reactive species generated by anodic oxidation at the electrodes and setting the electrode potential, as well as electronic data processing installation for recording and integrating measured values and for controlling the arrangement.

The installation according to the invention is used to carry out the method according to the invention.

In the method according to the invention, the deionized water used in the pretreatment installation is anodically oxidized preferably in at least one of the arrangements described above with the aid of at least one of the electrodes described above, the voltage at the electrode during operation always being below the potential range at which relatively large amounts of oxygen are evolved at the electrode. It is preferable for the voltage at the electrode during operation to be precisely within the potential range at which evolution of oxygen commences.

Preferably, the electrode is not pre-polarized prior to its initial use.

It is particular preferable for the electrode, prior to initial operation, to be provided with a charge of from 0.01 to 1 C/cm² of electrode surface area by a pretreatment.

In the method according to the invention, it is very particularly preferable for the deionized water to be circulated past at least one electrode.

The electrodes that are to be used according to the invention, their production and the conditions under which they are used are known in detail for example from European patent application EP 0 994 074 A2, page 2, paragraph [0010], page 7, paragraph [0091].

In a preferred embodiment, the installation according to the invention comprises at least one apparatus which is used to discharge and work up aqueous media from the installation according to the invention.

In this case, the apparatus for discharging and working up aqueous media from the inventive installation can be used to discharge and work up the waste waters from the pretreatment installation.

However, the apparatus for discharging and working up aqueous media from the coating installation can also be used to discharge excess aqueous coating substances, in particular overspray, from the coating apparatus and to separate the solids of the aqueous coating substances from their aqueous phases. The apparatus for discharging and working up excess aqueous coating substances from the coating apparatus preferably comprises at least one ultrafiltration apparatus, in which the solids of the aqueous coating substances are separated from their aqueous phases.

Furthermore, the apparatus for discharging and working up aqueous media from the installation according to the invention can be used to discharge and work up aqueous media from the hardening apparatus.

It is particularly preferable for the installation according to the invention to comprise all three of the apparatuses mentioned above for discharging and working up aqueous media from the installation according to the invention.

It is particularly preferable for at least one of the above-described apparatuses for discharging and working up aqueous media from the installation according to the invention, in particular all of the apparatuses, in each case to be connected to at least one arrangement for the anodic oxidation of the waste waters from the pretreatment installation, from the separated-off aqueous phases of the excess aqueous coating substances, from the coating apparatus and/or from the aqueous media from the hardening apparatus, each arrangement comprising at least one electrode which has a layer (3) of diamond on a base body (1, 2). It is very particularly preferable for the arrangements described above to be used for the anodic oxidation. In particular, the anodic oxidation in each arrangement is carried out in accordance with the method according to the invention.

The installation according to the invention, in particular the painting installation according to the invention for the production of automotive OEM finishes, provides coatings, in particular automotive OEM finishes, of particularly high quality. In particular, the automotive OEM finishes are completely or virtually completely free of coating defects, with the result that the complex further treatment of the painted bodies is not required or is only required to a very minor extent. The quality of the automotive OEM finishes is so high as to be eminently suitable for painting particularly high-value luxury automobiles.

The method according to the invention effectively prevents the formation of biofilms in the deionized water which is used in the pretreatment installation of the coating installation according to the invention. However, it not only effectively prevents the formation of biofilms but also eliminates biofilms which have already been formed and/or have become detached again from the walls, with the result that their can no longer be any undesired deposits on the substrate. This is ensured even at deionized water temperatures of from 30 to 45° C., with long tank lives and/or in the event of phosphate contamination, and not just for a short time, but even for a prolonged period of time. The method according to the invention also prevents disinfectants from being entrained into other parts of the painting installation, where they would change, in particular damage, the coating substances.

In the preferred embodiment described above, the installation according to the invention not only has the particular advantages that have been described above but can also be operated in a particularly economical and environmentally friendly way.

1. A coating installation, comprising:
at least one pretreatment installation;
at least one coating apparatus; and
at least one hardening apparatus,
wherein at least one pretreatment installation comprises at least one arrangement for the anodic oxidation of deionized water used in the pretreatment installation and further wherein at least one arrangement comprises at least one electrode, the electrode having a layer of diamond on a base body.

2. The coating installation of claim 1, wherein the electrode has a large-area layer of diamond on a base body.

3. The coating installation of claim 1, wherein the layer of diamond is from 2 to 50 μm thick.

4. The coating installation of claim 2, wherein the layer of diamond is doped with boron in an amount between 10 ppm and 10 000 ppm.

5. The coating installation of claim 1, wherein the base body, comprises a self-passivating metal.

6. The coating installation of claim 1, wherein the electrode comprises a bonding intermediate layer disposed between the base body and the layer of diamond, wherein the bonding intermediate layer is oxidation-stable during electrolysis.

7. The coating installation of claim 5, wherein the base body has a core of conductive material surrounded by a sheath of self-passivating metal.

8. The coating installation of claim 1, wherein the base body is formed from expanded metal.

9. The coating installation of claim 1, wherein the arrangement for the anodic oxidation of the deionized water used in the pretreatment installation is connected to an activation zone of the pretreatment installation so that the deionized water can be circulated through the arrangement.

10. The coating installation of claim 1, wherein the arrangement for the anodic oxidation of the deionized water used in the pretreatment installation is connected to a rinsing zone of the pretreatment installation so that the deionized water can be circulated through the arrangement.

11. The coating installation of claim 1, wherein the coating installation comprises at least one discharge apparatus.

12. The coating installation of claim 11, wherein the discharge apparatus discharges excess aqueous coating substances from the coating apparatus and separates the solids of the aqueous coating substances from their aqueous phases.

13. The coating installation of claim 12, wherein the discharge apparatus comprises at least one ultrafiltration apparatus, in which the solids of the aqueous coating substances are separated from their aqueous phases.

14. The coating installation of claim 11, wherein the discharge apparatus discharges and treats aqueous media from the hardening apparatus.

15. The coating installation of claim 11, wherein the discharge apparatus is connected to at least one arrangement for the anodic oxidation of the waste waters from at least one of the pretreatment installation,
the separated-off aqueous phases of the excess aqueous coating substances, from the coating apparatus or
the aqueous media from the hardening apparatus, so that the deionized water can be circulated through the arrangement,
the arrangement comprising at least one electrode which has a layer of diamond on a base body.

16. A method for treating a pretreatment installation in a coating installation comprising: anodically oxidizing deionized water used in the pretreatment installation with the aid of at least one electrode, wherein the electrode comprises a layer of diamond on a base body and further wherein the electrode operates at a voltage below the potential range at which oxygen is evolved at the electrode.

17. The method as of claim 16, wherein the voltage at the electrode during operation is precisely within the potential range at which evolution of oxygen commences.

18. The method of claim 16, wherein the electrode is not pre-polarized.

19. The method of claim 16, wherein the electrode, prior to initial operation, is provided with a charge of from 0.01 to 1 Coulomb/cm² of electrode surface area by a pretreatment.

20. The method of claim 16, wherein the deionized water is circulated past at least one electrode.

21. The coating installation of claim 2, wherein the layer of diamond is doped.

22. The coating installation of claim 5, wherein the self-passivating metal comprises at least one of titanium, niobium, tantalum, zirconium, tungsten or an alloy comprising at least one of these metals, with at least one of silicon, silicon carbide, silicon-infiltrated silicon carbide, or silicon-based ceramics.

23. The coating installation of claim 6, wherein the bonding intermediate layer is a metal carbide.

24. The coating installation of claim 11, wherein the discharge apparatus discharges and treats waste water from the pretreatment installation.

25. A coating installation, comprising:
at least one pretreatment installation;
at least one coating apparatus;
at least one hardening apparatus; and
at least one discharging apparatus,
wherein at least one pretreatment installation comprises at least one arrangement for the anodic oxidation of deionized water used in the pretreatment installation and further wherein at least one arrangement comprises at least one electrode, the electrode having a layer of diamond on a base body.
